(19) United States
(12) Patent Application Publication
(10) Pub. No.: US 2010/0235568 A1
(43) Pub. Date: Sep. 16, 2010

(54) STORAGE DEVICE USING NON-VOLATILE MEMORY

(75) Inventor: Seiji INAMURA, Kawasaki-shi (JP)

Correspondence Address: KNOBBE MARTENS OLSON & BEAR LLP, 2040 MAIN STREET, FOURTEENTH FLOOR, IRVINE, CA, 92614, US

(73) Assignee: TOSHIBA STORAGE DEVICE CORPORATION, Tokyo (JP)

(21) Appl. No.: 12/719,392

(22) Filed: Mar. 8, 2010

(30) Foreign Application Priority Data
Mar. 12, 2009 (JP) 2009-059768

(51) Int. Cl. G06F 12/00; G06F 12/02; G06F 1/26; G06F 12/08

(52) U.S. Cl. 711/103; 713/300; 711/118; 711/E12.001; 711/E12.008

(57) ABSTRACT

According to one embodiment, a storage device includes a plurality of writable non-volatile memory devices, a buffer memory, a memory controller, and a spare non-volatile memory device. The buffer memory temporarily stores write data from a host. The memory controller writes the write data in the buffer memory to the non-volatile memory devices in a distributed manner. The memory controller writes write data in the buffer memory not having been written to the non-volatile memory devices to the spare non-volatile memory device when detecting a power down, and writes the write data having been written to the spare non-volatile memory device to the buffer memory when the power is restored.

### CROSS-REFERENCE TO RELATED APPLICATIONS

This application is based upon and claims the benefit of priority from Japanese Patent Application No. 2009-059768, filed on Mar. 12, 2009, the entire contents of which are incorporated herein by reference.

### BACKGROUND

1. Field

One embodiment of the invention relates to a storage device using non-volatile memory.

2. Description of the Related Art

Magnetic disk devices are widely used as writable non-volatile storage devices. Higher-speed read/write performance is required for these devices. Therefore, a storage device comprising a flash memory that is one of non-volatile memories is used. This storage device is used as a high-speed and durable Solid State Drive (SSD).

When writing data to this flash memory, erasing and writing are performed block by block. Therefore, to use the storage device as an SSD, a time of tens of milliseconds is required because writing is performed at least on a per-page basis (for example, 512 bytes to 4 Kbytes per page). When continuous writing occurs, if writing to the flash memory is performed without doing anything, time is consumed by the write operation. Therefore, the performance decreases because non-response time to a host computer is prolonged.

To speed up the response to the host computer, the storage device once saves received data in a buffer memory or the like, and then immediately sends a response to the host. The data is written to the flash memory after a certain number of blocks are stored in the buffer memory or the SSD device becomes idle. In this way, the time used for writing is compensated.

When the power is shut down during the write operation, the device stops without writing the data in the buffer memory including a volatile memory to the flash memory. Or, since the power down occurs while a specific physical address in the flash memory is being written, the data in the physical address is broken.

There has been proposed a method to prevent the data loss due to the power down during the write operation. For example, the buffer memory includes a non-volatile memory such as a flash memory, and data writing is duplicated. For example, Japanese Patent Application Publication (KOKAI) No. 2006-113841 discloses a conventional technology to prevent the data loss due to power down of the storage device using a flash memory.

However, as described above, it takes a long time to write data to non-volatile memory. Therefore, a response to the host delays because it takes a long time to write the write data from the host to the buffer memory. In addition, since non-volatile memory is expensive, non-volatile memory is not suitable to be used as a buffer memory of a large capacity from the view point of cost.

Considering the occurrence of power down, a countermeasure is possible in which a battery or a capacitor is mounted on the SSD and data stored in the buffer memory is written to the SSD within a time period while the battery or the capacitor is charged. However, the capacity of the buffer memory is as large as hundreds of megabytes, and hence writing may be difficult in the charged time period while power is being supplied to a large number of flash memories.

The capacity of the battery may be increased. However, the size of the battery which can be mounted is limited because the size of the SSD is required to be as small as 3.5-inch size or 2.5-inch size magnetic disk devices.

### BRIEF DESCRIPTION OF THE SEVERAL VIEWS OF THE DRAWINGS

A general architecture that implements the various features of the invention will now be described with reference to the drawings. The drawings and the associated descriptions are provided to illustrate embodiments of the invention and not to limit the scope of the invention.

FIG. 1 is an exemplary block diagram of a storage device according to an embodiment of the invention;

FIG. 2 is an exemplary schematic diagram for explaining normal access in the storage device of FIG. 1 in the embodiment;

FIG. 3 is an exemplary schematic diagram for explaining a power supply state when power is down in the storage device of FIG. 1 in the embodiment;

FIG. 4 is an exemplary flowchart of data save operation when power is shut down in the embodiment;

FIG. 5 is an exemplary schematic diagram for explaining a management table in FIG. 4 in the embodiment;

FIG. 6 is an exemplary schematic diagram for explaining a save operation to a spare non-volatile memory device in FIG. 4 in the embodiment;

FIG. 7 is an exemplary schematic diagram for explaining a relationship between an address management table of the spare non-volatile memory device in FIG. 4 and physical blocks in the embodiment;

FIG. 8 is an exemplary flowchart of data restoration operation when power is restored in the embodiment; and

FIG. 9 is an exemplary schematic diagram for explaining the data restoration operation illustrated in FIG. 8 in the embodiment.

### DETAILED DESCRIPTION

Various embodiments according to the invention will be described hereinafter with reference to the accompanying drawings. In general, according to one embodiment of the invention, a storage device comprises a plurality of writable non-volatile memory devices, a buffer memory, a memory controller, and a spare non-volatile memory device. The buffer memory is configured to temporarily store write data from a host. The memory controller is configured to write the write data in the buffer memory to the non-volatile memory devices in a distributed manner. The memory controller is configured to write data in the buffer memory not having been written to the non-volatile memory devices to the spare non-volatile memory device when detecting a power down, and write the write data having been written to the spare non-volatile memory device to the buffer memory when the power is restored.

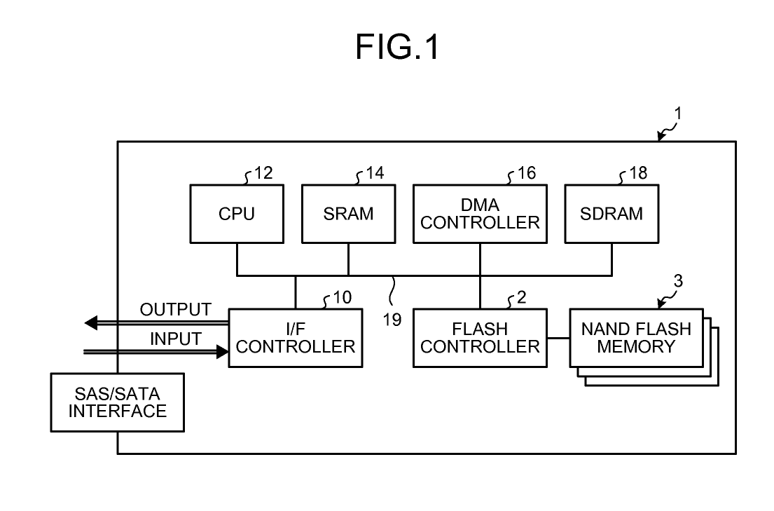

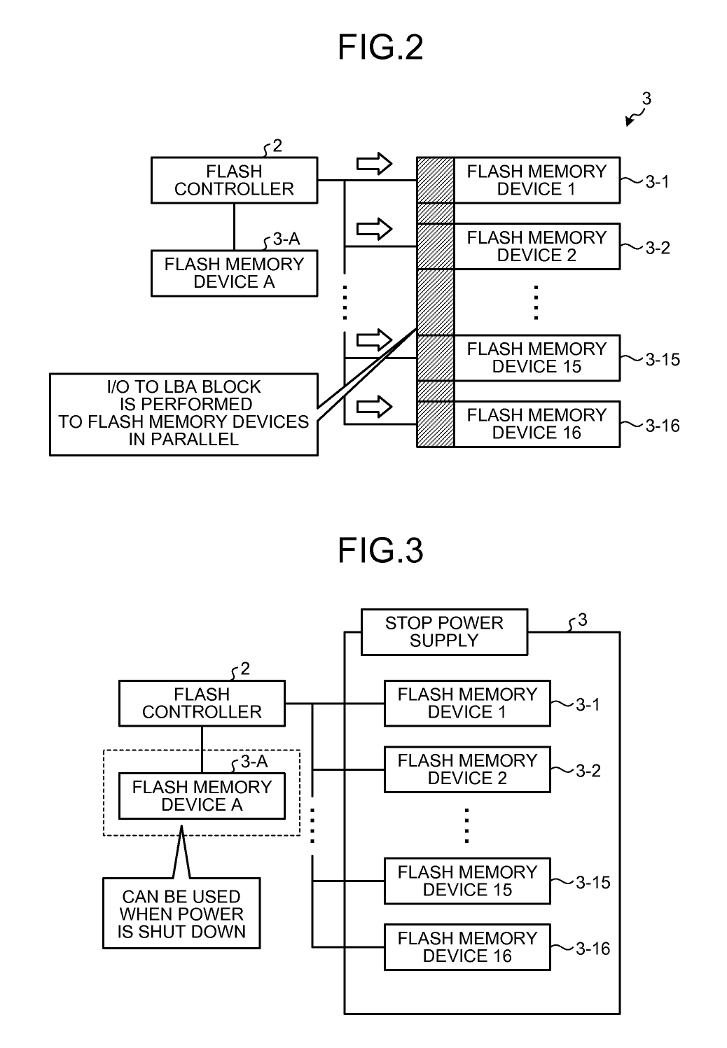

FIG. 1 is a block diagram of a storage device according to an embodiment of the invention. FIG. 2 illustrates normal access in the storage device. FIG. 3 illustrates a power supply state when power is shut down in the storage device. FIG. 1 illustrates a Solid State Drive (SSD), in which flash memories are used as a non-volatile memory, as an example of the storage device.

As illustrated in FIG. 1, an SSD 1 comprises an interface (I/F) controller 10, a Centralized Processor Unit (CPU) 12, a Static Random Access Memory (SRAM) 14, a Direct Memory Access (DMA) controller 16, a Static Dynamic Random Access Memory (SDRAM) 18, a flash controller 2, and a plurality of flash memories 3.

The I/F controller 10, the CPU 12, the SRAM 14, the DMA controller 16, the SDRAM 18, and the flash controller 2 are connected by a bus 19. The I/F controller 10 controls an interface to a host (for example, a CPU in a personal computer) (not illustrated in FIG. 1). For example, the I/F controller 10 controls a Serial Attached SCSI (SAS) interface and a Serial AT Attached (SATA) interface.

The CPU 12 controls the overall operation of the SSD 1 according to a program and parameters stored in the SRAM 14. For example, the CPU 12 analyzes a command from the host and executes the command. The SDRAM 18 comprises a work area of the CPU 12 and a buffer memory for read/write data.

The DMA controller 16 performs data transfer between the flash controller 2 and the buffer memory in the SDRAM 18, and data transfer between the buffer memory in the SDRAM 18 and the I/F controller 10 by a DMA instruction from the CPU 12.

The flash controller 2 is connected to the flash memories 3, and performs data read/write control of the flash memory 3. The flash memory 3 reads or writes the data at every blocks composed of an NAND type flash memory.

As illustrated in FIG. 2, the flash memory 3 comprises a plurality of flash memory devices 3-1 to 3-16 (for example, 16 flash memory devices in the embodiment) connected in parallel to the flash controller 2 and a second flash memory device 3-A. For example, when a memory capacity of one flash memory device is 128 Mbytes, an SSD of 128*16=2088 Mbytes=2 Gbytes can be constituted by 16 flash memory devices.

In normal operation, the flash controller 2 accesses an arbitrary block in the flash memory devices 3-1 to 3-16 for read/write of a Logical Block Address (LBA). For example, assuming that one LBA is 1024 bytes, the LBA is divided into 1024/16=64 bytes blocks, and a physical area in each of the 16 flash memory devices 3-1 to 3-16 is assigned.

In this way, by performing a read/write operation by parallel access, the, time required to perform a read/write operation on a flash memory, in particular to perform a write operation on a flash memory, is reduced. Therefore, in normal operation, power is required to be continuously supplied to the 16 flash memory devices 3-1 to 3-16.

As illustrated in FIG. 3, when power is shut down, the power supply is cut off, and an attached battery backup starts. At this time, to suppress power consumption, regarding the parallel connected flash memory devices 3-1 to 3-16 and the second flash memory device 3-A, power supplies to the flash memory devices 3-1 to 3-16 except for the second flash memory device 3-A are stopped. Therefore, a write operation is performed on only the specific flash memory device 3-A.

Although the flash memory device of the embodiment uses a NAND type flash memory, the storage device need not necessarily be a flash memory device, but any memory device which consumes less power and can satisfy a required capacity may be used. The power consumption can be reduced by such a power supply when power is shut down.

When the write operation is performed in parallel as illustrated in FIG. 2, to perform the write operation on the flash memory devices 3-1 to 3-16, an additional power is consumed to search physical addresses from logical addresses (LBAs) to convert the logical addresses into the physical addresses by using a management table.

On the other hand, when the power is shut down in FIG. 3, data not having been written yet and the management table which are stored in the buffer memory are entirely written to the second flash memory device 3-A. Therefore, the search operation consumes little electrical power.

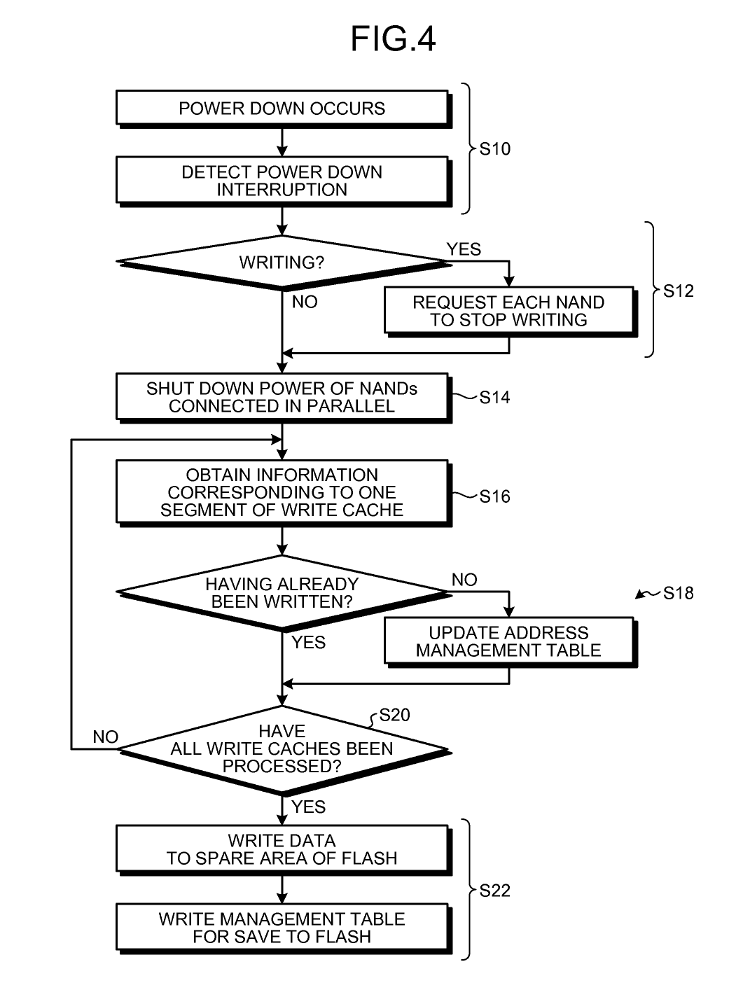

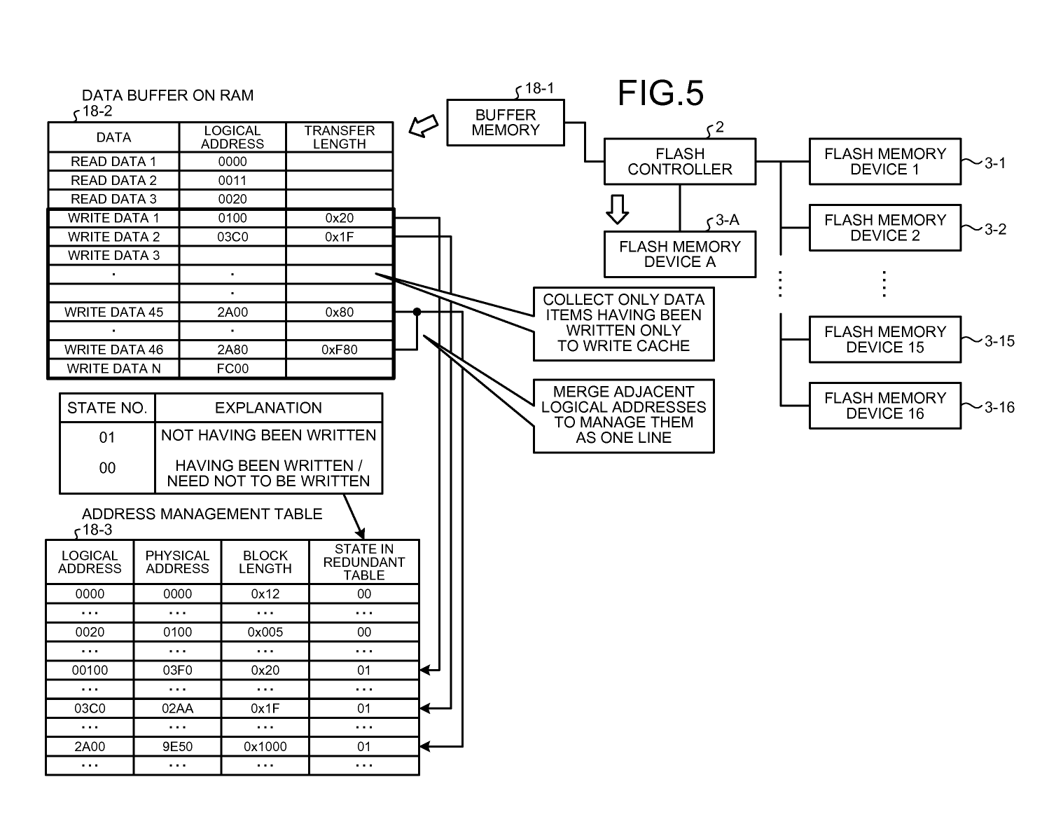

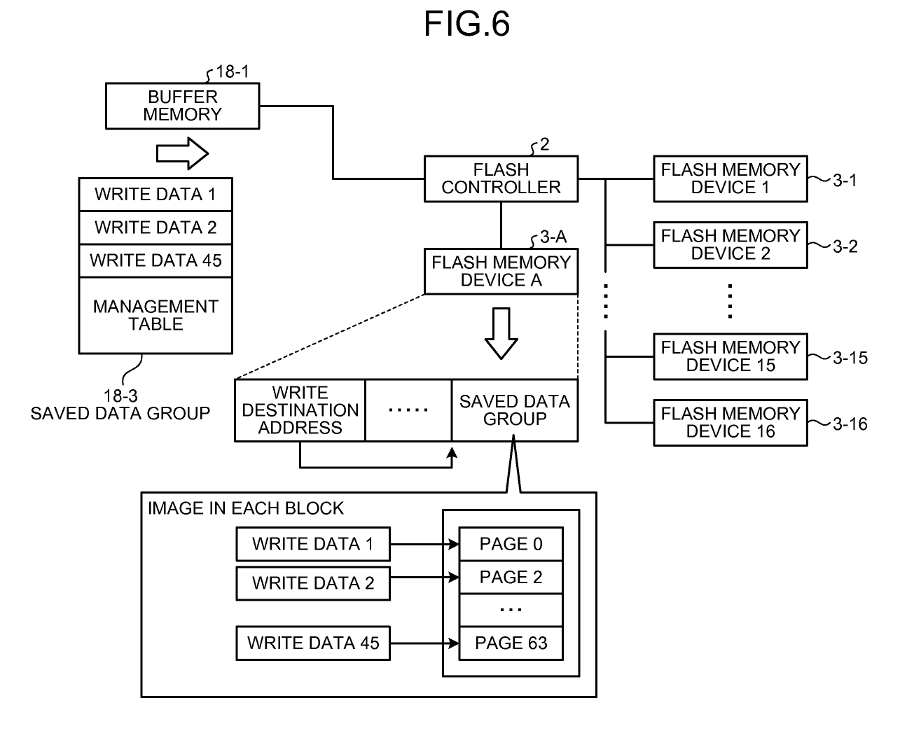

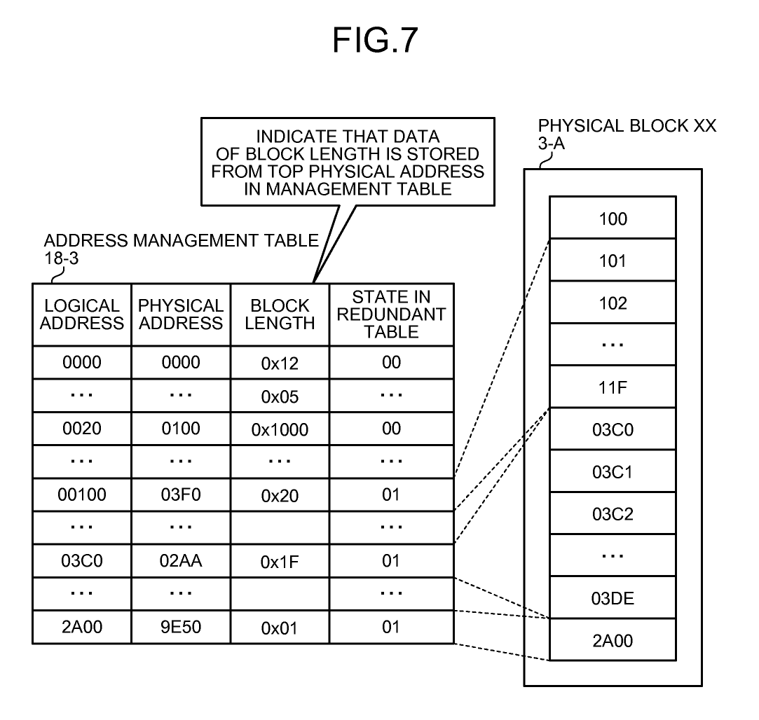

FIG. 4 is a flowchart of data save operation when power is shut down according to the embodiment. FIG. 5 illustrates an address management table. FIG. 6 illustrates the data save operation. FIG. 7 illustrates a relationship between the address management table and physical blocks.

A buffer memory 18-1 will be described with reference to FIG. 5 before the operation of the flash controller 2 illustrated in FIG. 4. The buffer memory 18-1 provided in the SDRAM 18 is mainly divided into a write cache memory in which write data is stored in write operation and a read cache memory in which read data is stored in read operation.

As illustrated in FIG. 5, the buffer memory 18-1 comprises a data buffer module 18-2 and an address management table 18-3. The data buffer module 18-2 includes the read cache memory and the write cache memory. In FIG. 5, the shaded area indicates read data and write data having already been written and the non-shaded area indicates write data not having been written yet.

The data buffer module 18-2 stores data (read data or write data), start logical address (LBA), and transfer length. For example, in FIG. 5, the write data 1 in the data buffer module 18-2 is the start logical address “0100” and the transfer length “0x20”.

On the other hand, the address management table 18-3 manages data addresses in the flash memory devices 3-1 to 3-16. The address management table 18-3 comprises logical addresses (LBAs), physical addresses in the flash memory devices 3-1 to 3-16, block lengths, and redundant information. The redundant (state) information indicates that the write data has already been written or the write data has not been written yet or need not be written.

The flash memory device reports a completion status to the host immediately after the flash memory device has stored the write data from the host in the write cache memory of the buffer memory 18-1.

In particular, the flash memory takes a long time to write data. Accordingly, the flash memory device writes the write data in bulk when the system is idle or the like to improve the performance. Therefore, when a power down occurs, there may be some data which has not yet been written to the flash memory on the write cache memory on the buffer memory 18-1.

Next, the operation of the flash controller 2 illustrated in FIG. 4 will be described with reference to FIGS. 5 to 7.

The flash controller 2 detects a power down interruption when a power down occurs, and starts data save operation (S10).

The flash controller 2 determines whether data is being written (also referred to as “being programmed”) to the flash memory devices 3-1 to 3-16. When data is being written, the flash controller 2 requests the flash memory devices 3-1 to 3-16 to stop the writing (S12).

The flash controller 2 shuts down the power of the parallel connected flash memory devices 3-1 to 3-16. Specifically, the state in which power is supplied as illustrated in FIG. 2 shifts to the state in which only the second flash memory device 3-A is supplied with power from the battery as illustrated in FIG. 3 (S14).

The flash controller 2 obtains information corresponding to one segment of the write cache memory in the buffer memory 18-1 (S16). Specifically, the flash controller 2 refers to the state (redundant) information (see FIG. 5) of a physical address specified by the address management table 18-3.

The flash controller 2 extracts only the write data whose state of the state information is a state of not yet having been written (state “01”) as a write (save) target. As illustrated in FIG. 5, the flash controller 2 updates the address management table 18-3 comprising the logical addresses, the physical addresses, the block lengths, and the redundant information of the extracted write data (S18).

At this time, there may be write data items which are stored as separate data items in the write cache memory even if the write data items may have a sequential relationship. For example, in FIG. 5, write data 45 has a start LBA of “2A00” and a transfer length of “0x80”, and write data 46 has a start LBA of “2A80”. Therefore, the write data 46 is sequential data following the write data 45.

The flash controller 2 determines whether there are write data items having a sequential relationship from the start LBAs and the transfer lengths of the obtained write data items, and handles the sequential data items as one sequential data item on the address management table 18-3. In other words, in the example of FIG. 5, the write data 45 and the write data 46 are combined, and the address management table 18-3 is updated to have write data of the logical address (LBA) of “2A00”, the physical address of “9E50”, and the block length of “0x1000”.

When many data items are sequentially located one by one in the write cache memory, the data items are combined to one management unit having the logical address of “0x2A00” as illustrated in FIG. 5 so that the management table is streamlined.

The flash controller 2 determines whether all the write data not having been written yet to the address management table 18-3 of the buffer memory 18-1 has been extracted (S20). When the flash controller 2 determines that all the write data not having been written yet to the address management table 18-3 of the buffer memory 18-1 has not been extracted, the process returns to S16.

When determining that all the write data not having been written yet in the address management table 18-3 of the buffer memory 18-1 has been extracted, as illustrated in FIG. 6, the flash controller 2 extracts only the write data to be written, and then performs processing to write a data group comprising the address management table 18-3 to the flash memory device 3-A (S22).

Normally, when data is written to a physical area, only data items having continuous logical addresses are written to one block, and data items having random logical addresses are written to different blocks. However, in the embodiment, as illustrated in FIG. 7, regardless of whether there are continuous data items, the writing time is shortened by storing data in a block as close as possible.

In the address management table 18-3, normally, data has a start logical address for each host access, and hence the logical address and the transfer length are registered in the address management table 18-3 for each access even when sequential access continues.

When the power is shut down, for the sequential access, only the sequential access start address (top physical address) and a total transfer length (block length) in the management table are stored as the address management table 18-3. In this way, the required capacity of the address management table 18-3 can be reduced.

FIG. 7 illustrates that data corresponding to the block length is stored from the top address in the management table 18-3, and data is stored as close as possible in a block of the flash memory device 3-A regardless of whether there is continuous data.

As described above, since only necessary data in the data stored in the buffer memory 18-1 is written, the power consumption during the writing time can be reduced.

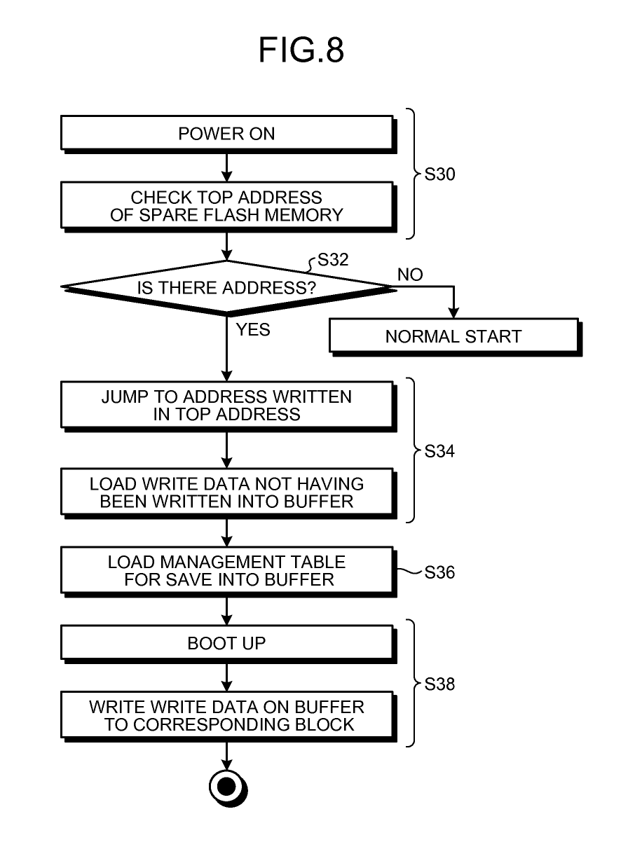

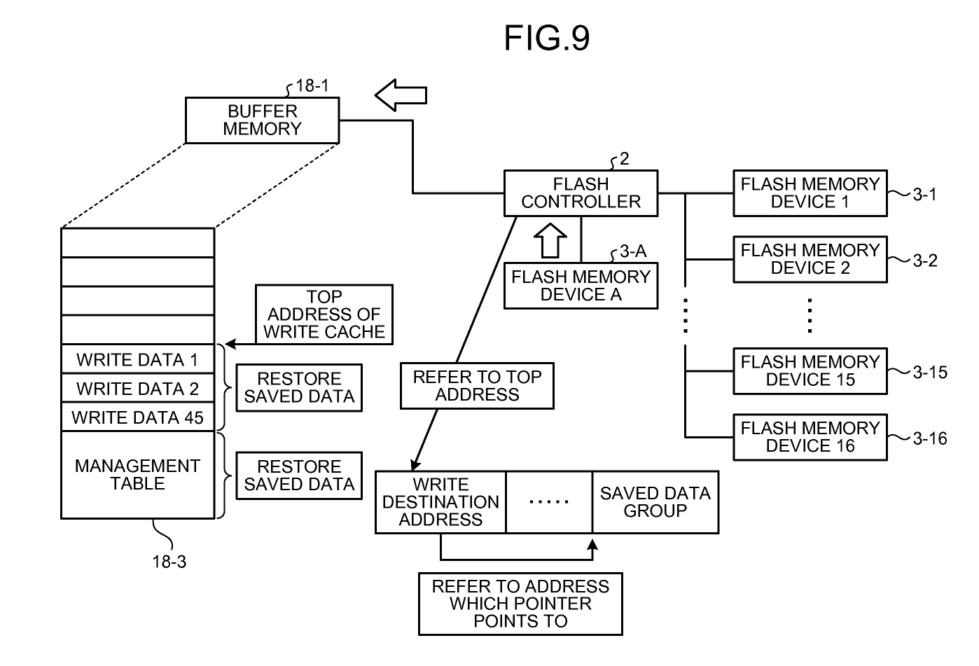

Next, data restoration operation when power is restored such as when the power is turned on will be described. FIG. 8 is a flowchart of the data restoration operation when power is restored according to the embodiment. FIG. 9 illustrates the data restoration operation in FIG. 8.

The data restoration operation by the flash controller 2 in FIG. 8 will be described with reference to FIG. 9.

When the flash controller 2 is informed that the power is turned on, the flash controller 2 checks the top address of the flash memory device 3-A. When the flash controller 2 writes save data to the flash memory device 3-A in the write operation at S22 of FIG. 4, the flash controller 2 writes the address of the write destination (S30).

When a pointer address is not written to the top address of the second flash memory device 3-A, the flash controller 2 determines that the saved data is not written to the second flash memory device 3-A when the power is shut down, and performs a normal start operation (S32).

When determining that the pointer is written to the top address of the second flash memory device 3-A, the flash controller 2 refers to the address of the pointer, and fixes the address of the saved data group. The flash controller 2 copies a stored amount of write data, which is stored in the second flash memory device 3-A from the top address of the saved data group, to the area starting from the top address of the write cache memory of the buffer memory 18-1, by referring to the management table 18-3 (see FIG. 9) (S34).

Next, the flash controller 2 copies the management table 18-3 to a predetermined position in the buffer memory 18-1. After the copy, the area of the second flash memory device 3-A becomes free (S36).

Thereafter, the flash controller 2 boots up, and writes the write data in the buffer memory 18-1 to corresponding blocks in the flash memory devices 3-1 to 3-16 (S38).

In this way, the data saved when the power is shut down can be restored in the buffer memory 18-1.

Although the above embodiment is described taking a flash memory as an example of a writable non-volatile memory, the embodiment may be applied to other writable non-volatile memories. In addition, the second flash memory device 3-A can be used as a spare memory when a failure occurs in a flash memory.

The various modules of the systems described herein can be implemented as software applications, hardware and/or software modules, or components on one or more computers, such as servers. While the various modules are illustrated separately, they may share some or all of the same underlying logic or code.

While certain embodiments of the inventions have been described, these embodiments have been presented by way of example only, and are not intended to limit the scope of the inventions. Indeed, the novel methods and systems described herein may be embodied in a variety of other forms; furthermore, various omissions, substitutions and changes in the form of the methods and systems described herein may be made without departing from the spirit of the inventions. The accompanying claims and their equivalents are intended to cover such forms or modifications as would fall within the scope and spirit of the inventions.

What is claimed is:

1. A storage device comprising:
a plurality of writable non-volatile memory devices;
a buffer memory configured to temporarily store write data from a host;
a memory controller configured to write the write data in the buffer memory to the non-volatile memory devices in a distributed manner; and
a spare non-volatile memory device,
wherein the memory controller is configured to write the write data in the buffer memory not yet written to the non-volatile memory devices to the spare non-volatile memory device when detecting a power down, and write the write data written to the spare non-volatile memory device to the buffer memory when the power is restored.

2. The storage device according to claim 1, wherein the memory controller is configured to supply a spare power to only the spare non-volatile memory device when detecting the power down.

3. The storage device according to claim 1, further comprising:
an interface circuit configured to control an interface to the host; and
a control circuit configured to analyze a command from the host, write the write data to the buffer memory, and notify the host of processing completion.

4. The storage device according to claim 1, wherein
the buffer memory comprises a management table for storing a logical address of the write data and a redundant information indicating whether the write data has already been written for each write data item, and
the memory controller is configured to extract the write data not yet written based on the redundant information.

5. The storage device according to claim 4, wherein the memory controller is configured to create an address management table of the write data not yet written from the management table, and write the address management table to the spare non-volatile memory device.

6. The storage device according to claim 5, wherein the memory controller is configured to combine management information items from a plurality of write data items which have not been written and have a sequential relationship in the buffer memory, update the address management table, and write the address management table to the spare non-volatile memory device.

7. The storage device according to claim 3, wherein the buffer memory is a read and write cache memory of the non-volatile memory devices.

8. The storage device according to claim 7, wherein the memory controller is configured to access the non-volatile memory devices in parallel to perform read and write operations.

9. The storage device according to claim 5, wherein the memory controller is configured to sequentially write the write data items not yet written to a continuous area in the spare non-volatile memory device, and update the address management table storing a physical address of the continuous area for the write data items not yet written.

10. The storage device according to claim 5, wherein the memory controller is configured to write the write data to a predetermined area in the buffer memory according to the address management table stored in the spare non-volatile memory device when the power is restored.

11. The storage device according to claim 1, wherein
the non-volatile memory devices comprise a flash memory, and
the memory controller comprises a flash controller.
